(19) United States
(12) Patent Application Publication
(10) Pub. No.: US 2015/0307770 A1
(43) Pub. Date: Oct. 29, 2015

(54) CLEAN FRACTURING FLUID THICKENER OF MULTI-BLOCK ASSOCIATIVE COPOLYMER (APCF) AND METHOD PREPARING THEREOF

(71) Applicants: Yan Zheng, Beijing (CN); Yujian Luo, Beijing (CN); Xiaodan Bai, Beijing (CN)

(72) Inventors: Yan Zheng, Beijing (CN); Yujian Luo, Beijing (CN); Xiaodan Bai, Beijing (CN)

(21) Appl. No.: 14/259,407

(22) Filed: Apr. 23, 2014

(51) Int. Cl. C09K 8/62; C08F 228/02; C08F 220/56

(52) U.S. Cl. CPC C09K 8/62; C08F 220/56; C08F 228/02

(57) ABSTRACT

The present invention relates to a Clean Fracturing Fluid Thickener of Multi-block Associative Copolymer (APCF) and a method preparing thereof. Said Copolymer has evaluating indicators as: (1), the viscosity of its 0.3% water solution at 20° C.≧30 mPa·s; (2), the viscosity of said solution after gel breaking≦5 mPa·s; and, (3) a static sand-suspending time of said solution≧10 min.

### CROSS-REFERENCE TO RELATED APPLICATIONS

The present application claims priority under 35 U.S.C. §119 to Chinese patent application 201310172795.X, filed May 10, 2013, the disclosure of which is incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

1. Technical Field

The present invention relates to a Clean Fracturing Fluid Thickener of Multi-block Associative Copolymer APCF) and a method preparing thereof.

2. Background

Fracturing generates cracks having conductivity in the strata, wherein fracturing fluid used in the fracturing may largely determine effect of the fracturing. At the same time, certain requirements have been imposed on the viscosity of the fracturing fluid, whereas said fracturing fluid may convert into low-viscosity fluid thus be easily flew back to ground after the fracturing, which avoiding damages to reservoirs.

Currently, the fracturing fluids commonly used include water-based, oil-based, foamed and emulsified fracturing fluids. The water-based fracturing fluids have advantages such as low cost, high safety, etc. Currently, they are of the most widely use.

Fracturing fluid thickener is the most important additive to the water-based fracturing fluids, which has a history of development for half a century. Many types of the water-based fracturing fluid thickeners are in current use. Based on their chemical structures, they could be categorized into three classes; natural galactomannan class, cellulose class and synthetic polymer class.

The natural galactomannan class fracturing fluid thickeners mainly include guar gum, hydroxypropyl guar gum, carboxymethyl guar gum, hydroxypropylcarboxymethyl guar gum and so on. The guar gum with linear structure is produced from guar. The guar has genetworkic features such as heat-loving, drought-tolerant and sun-sensitivity, all of which limit its geographic distribution. Increasing demands for the guar in producing the water-based fracturing fluid thickener also stretches its resources and pushes its price high.

Other Vegetable gums, such as seania gum, fenugreek gum, konjac gum and gleditschiasinensis gum, have not bee applied in large-scales due to their costs and unstable performances. Moreover, the fracturing fluids with the natural galactomannan class fracturing fluid thickeners have incomplete gel breaking, thus residues after the gel breaking were left in strata cracks, which may severely reduce the permeability of proppant filled layers, damage the strata, and result in poorer fracturing effect, all of which restrict development of said thickeners.

The cellulose class fracturing fluid thickeners include carboxymethyl cellulose (CMC), hydroxyethyl cellulose (HEC), hydroxypropylcarboxymethyl cellulose (CMHPC) and hydroxypropyl methyl cellulose (HPMC) and alike. The cellulose class fracturing fluid thickeners generally have disadvantages such as salt-sensitivity, thermal-instability, poor thickening-ability, and crack-blockage due to their residues, all of which restrict their field applications.

In recent years, the synthetic polymer class fracturing fluid thickeners or synthetic polymeric thickeners have become a hot research direction. Compared with natural polymers, synthetic polymers have features such as superior thickening ability, excellent gel breaking performance, and low residue and so on. The synthetic polymeric thickeners mainly include polyacrylamide, sodium polyacrylate, polyacrylate, polyvinyl amine and polyvinyl alcohol. The shortcomings of traditional polymer-based fracturing fluid thickener are poor salt & thermal tolerance, and poor shear stability.

To enable an improved performance of polymer-based fracturing fluid, associative monomers are introduced to increase the molecular rigidity of molecular main chains of polymeric thickeners; and, to generate intermolecular association with certain strength, which leads to a reinforced network structure and results in an improved properties.

Overall, the associative monomers for the fracturing fluid thickener in the current market are characterized with poor association ability and lead to unstable network structure, thus uneven performances. Therefore, there is a need for developing associative monomers which may result in the synthetic polymer class fracturing fluid thickeners with superior properties.

### SUMMARY OF THE INVENTION

One object of the present invention is to provide a Clean Fracturing Fluid Thickener of Multi-block Associative Copolymer.

A further object of the present invention is to provide a method of preparing said Clean Fracturing Fluid Thickener of Multi-block Associative Copolymer.

According to the present invention, the Clean Fracturing Fluid Thickener of Multi-block Associative Copolymer has evaluating indicators as:
1) the viscosity of its 0.3% water solution at 20° C.≧30 mPa·s;
2) said viscosity after gel breaking≦5 mPa·s; and,
3) the static sand-suspending time≧10 min.

According to one embodiment of the present invention, the Clean Fracturing Fluid Thickener of Multi-block Associative Copolymer is prepared by following steps:
1) preparing multi-block associative monomers including: maleic acid n-alkyl ester sodium salt; n-alkylolacrylamide; n-alkyl dimethylally ammonium chloride or n-alkyl dimethyl p-methyl-phenylethenyl ammonium chloride; and, n-alkyl vinyl ether;
2) synthesizing the Clean Fracturing Fluid Thickener of Multi-block Associative Copolymer; and
3) post-treating the Clean Fracturing Fluid Thickener of Multi-block Associative Copolymer.

Accordingly, comparing with prior art, the present invention has following advantages:

First, it imposes less damage to reservoir. The thickener of the present invention is completely dissolves in water in absence of any sediment of flocculence-like insoluble. Fracturing fluid containing the thickener of the present invention does not produce any insoluble after gel breaking. Said fracturing fluid may achieve complete flowing back and reduce damage to the reservoir, thus is one of ideal clean fracturing fluids.

Second, the thickener of the present invention may be prepared using surface water and/or sea water.

Third, it has low viscosity with superior sand carrying capacity and low friction. Its diluted solution have a unique multi-associative effect, which shows excellent viscoelasticity and shear thinning capacity, and superior suspension to proppants. At the same time, said diluted solution exhibits excellent shear resistance, superior pressure-transduction, low friction; insignificant damage to the liquid rheology during pumping and percolation processes.

Fourth, it is rapidly dissolved, ideal for continuous solution preparation; it contains hydrophilic groups which facilitate a rapid dissolution for a low costing and in situ application.

### BRIEF DESCRIPTION OF DRAWINGS

FIG. 1 is a flowchart illustrating one embodiment of the present invention.

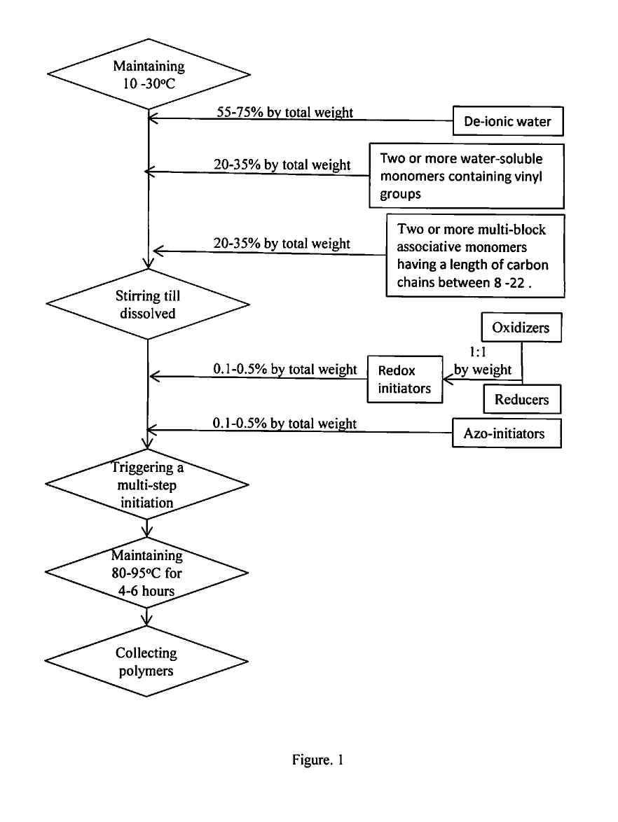

Table 1 A&B are lists showing components that are applied to one embodiment of the present invention showing in FIG. 1.

### DETAILED DESCRIPTION OF THE INVENTION

The present invention is related to a Clean Fracturing Fluid Thickener of Multi-block Associative Copolymer (the “APCF”) and a method preparing thereof.

According to the present invention, the APCF is prepared by introducing and associating at least two water-soluble monomers containing vinyl groups, and two to four associative monomers to a molecular chain. The associating is taking place through a multi-step initiation process in sealed reactors.

The water-soluble monomers containing vinyl groups include but not limited to: acrylamide, acrylic acid or methacrylic acid, sodium acrylate or potassium acrylate, sodium allylsulfonate, and 2-acrylamide-2-methylpropanesulfonic acid.

The associative monomers all have a length of carbon chains between 8-22. Said monomers include but not limited to maleic acid n-alkylester sodium salt, n-alkyl acrylamide, n-alkyl dimethylallyl ammonium chloride or n-alkyl dimethyl p-methyl-phenylethenyl ammonium chloride, and n-alkyl vinyl ether.

The water-soluble monomers containing vinyl groups are hydrophilic, thus facilitate dissolving process of the APCF in water and increase the viscosity of water solutions of the APCF. On the other hand, the associative monomers on the molecular chains form a stable 3-D network-like structure by directly associations among said monomers. Introductions of crosslinkers may further facilitates indirectly associations in the water solutions by ways of H-bonds, van der waals forces, ionic bonds and complexation bonds and form multi-element associated polymers' water solutions.

The cross linkers include but not limited to: negative charged ion surface-active crosslinkers; or, high valence ionic crosslinkers such as those containing Ca, Mg, Al and/or Ti.

According to the present invention, said solution has more stable structure, better salt, thermal and shear resistances, better rheological property, easier for gel breaking and flowing-back processes. Thus it is an idea thickener for on-site applications.

According to one embodiment of the present invention, the APCF is prepared by following steps:
1) preparing multi-block associative monomers including: maleic acid n-alkyl ester sodium salt; n-alky acrylamide; n-alkyl dimethyl allyl ammonium chloride and/or n-alkyl dimethyl p-methyl-phenylethenyl ammonium chloride; and, n-alkyl vinyl ether; and
2) synthesizing the Clean Fracturing Fluid Thickener of Multi-block Associative Copolymer (APCF); and,
3) post-treating the Clean Fracturing Fluid Thickener of Multi-block Associative Copolymer (APCF).

According to one embodiment of the present invention, the maleic acid n-alkyl ester sodium salt having the length of the carbon chains between 8-22 is prepared by following steps:
1) Maintaining a temperature within a first reactor at 10-30° C.;
2) Adding by total weight: 49.5-56.9% of methylbenzene, and 12-14% of maleic anhydride, stirring till dissolved;
3) Adding by total weight: 26-30% of long chain alcohol having the length of the carbon chains between 8 to 22, and 0.1-0.5% of 4-methylbenzensulfonic acid as catalyst, stirring till dissolved;
4) Sealing the first reactor air-tight and raising the temperature within the first reactor to 60-80° C., conducting a first reaction within said sealed reactor for 6-8 hours;
5) Neutralizing the first reaction by adding 5-6% by total weight of alkali for 1-2 hours, cooling down the first reaction to a room temperature;
6) Filtering the first reaction to collect white solid products, which is the maleic acid n-alkyl ester sodium salt.

For example, the alkali described hereabove could be sodium hydroxide.

According to one embodiment of the present invention, n-alkyl acrylamide having the length of the carbon chains between 8-22 is prepared by following steps:
1) Maintaining a temperature of a second reactor at 10-30° C.;
2) Adding by total weight: 45.5-51.9% of methylbenzene, and 38-42% of long chain alkyl amine having the length of the carbon chains between 8-22, stirring till dissolved;
3) Adding by total weight: 10-12% of acrylic acid, 0.1-0.5% of the catalyst such as 4-methylbenzenesulfonic acid, stirring till dissolved;
4) Sealing the second reactor air-tight and raising the temperature of the second reactor to 85-95° C. to conduct a second reaction for 20-24 hours, while removing water produced from the second reaction by a water separator;
5) Distilling by a reduced pressure distillation at 80-90° C. for 8-12 hours till no distillate distilled;
6) Collecting light-yellow oily solid products from the second reactor after said reactor is cooled down to the room temperature.

According to one embodiment of the present invention, the n-alkyl dimethylallyl ammonium chloride or the n-alkyl dimethyl p-methyl-phenylethenyl ammonium chloride having the length of the carbon chains between 8-22 is prepared by following steps:
1) Maintaining a temperature of a third reactor at 10-30° C.:
2) Adding by total weight: 30-32% of ethanol, and 48-50% of dimethyl-n-alkylamine having the length of the carbon chains between 8-22, stirring till dissolved;
3) Adding by total weight: 18-22% of chloroacrylate or 1-(chloromethyl)-4-ethenyl-benzen, stirring till dissolved;
4) Sealing the third reactor air-tight and raising the temperature of the third reactor to 50-60° C. to conduct a third reaction for 20-24 hours;
5) Distilling by the reduced pressure distillation at 80-90° C. for 8-12 hours until no distillate distilled; and,
6) Collecting white solid products from said reactor.

According to one embodiment of the present invention, the n-alkyl vinyl ether having the length of the carbon chains between 8-22 may be obtained commercially from existing market.

According to yet another embodiment of the present invention, the Clean Fracturing Fluid Thickener of Multi-block Associative Copolymer (APCF) is synthesized by following steps:
1) Maintaining a temperature of a stirring reactor at 10-30° C.;
2) Subsequently adding components by system weight: 55-75% of de-ionized water, 20-35% of at least two of the water-soluble monomers containing vinyl groups, and 5-10% of two to four of the multi-block associative monomers, stirring till dissolved; wherein the system weight is the combined weights of the de-ionized water, the water-soluble monomers containing vinyl groups, and the multi-block associative monomers;
3) Adding by total weight: 0.1-0.5% of redox initiators and 0.1-0.5% of azo-initiators to trigger a multi-step initiation;
4) Initiating a forth reaction by raising and maintaining the temperature of the stirring reactor at 80-95° C. for 4-6 hours; and
5) Collecting polymers produced from the forth reaction, which has a molecular weight between 200-400 million.

The redox initiators consist of oxidizers and reducers. For example, the oxidizers include but not limited to: sodium persulfate, potassium persulfate, or ammonium persulfate. The reducers include but not limited to: sodium bisulphite or sodium sulfite. The ratio between the oxidizer and the reducer may be 1:1 by weight.

For another example, the azo-initiators include but not limited to: azo-bis-iso-butyrynitrile, azo-bis-iso-heptonitrile, 2,2′-azobis[2-(2-imiddazolin-2-yl)propane] dihydrochloride, and/or 2,2′-azobis(2-methylpropionamidine) dihydrochloride.

According to one embodiment of the present invention, the post-treating process may consist of granulating, drying, grinding and packing of the polymers produced from steps described hereabove.

According to the present invention, the Clean Fracturing Fluid Thickener of Multi-block Associative Copolymer (APCF) may have evaluating indicators as:
1) the viscosity of its 0.3% water solution at 20° C.≧30 mPa·s;
2) said viscosity after gel braking≦5 mPa·s; and,
3) a static sand-suspending time≧10 min.

The viscosities of said solution described hereabove are tested by rheometers such as those produced by Haake Rheometers or similar products under 170 s⁻¹. The static sand-suspending time described hereabove is measured by recoding time starting from adding 20% by volume of ceramic particles into said 0.3% water solution under 20° C., and ending when all the ceramic particles settled on bottom.

### EMBODIMENTS

### Embodiment 1

### Preparing and Testing of APCF1

1. Maintaining a temperature within a reactor at 20° C., adding 80.55 g methylbenzene and 19.5 g maleic anhydride into a monomer reactor, stirring till dissolved; then adding 42 g dodecyl alcohol and 0.45 g 4-methylbenzenesulfonic acid, stirring till dissolved. Sealing the reactor and raising the temperature to 75° C. for reacting for 8 hours, the neutralizing by 7.5 g NaOH for 2 hours before cooling down to the room temperature. Filtrating and collecting solid component which is maleic acid monododecylexyl sodium salt.

2. Maintaining the temperature within the reactor at 20° C., adding 128 g de-ionic water, 30 g acrylamide and 30 g sodium allylsulfonate into a stirring reactor, stirring till dissolved; then, adding the multi-block associative monomers of maleic acid monododecylexyl sodium salt 6 g, 1-ethenyloxy-Hexadecane 6 g, stirring till dissolved. Next, adding sodium persulfate 0.4 g, sodium bisulphite 0.4 g, and azo-bis-iso-butyrynitrile 0.6 g to trigger the multi-step initiation. Raising the temperature to 90° C. for 4 hours for reacting.

3. Cooling down a product prepared from step 2 described hereabove, preparing the APCF1 by granulating, drying and grinding said product.

The APCF1 prepared from Embodiment 1 is in powder form, having the evaluating indicators described hereabove as 45 mPa·s at 20° C., 3 mPa·s after the gel breaking, and 120 min of the suspending sand time, respectively.

### Embodiment 2

### Preparing and Testing of APCF2

1. Maintaining a temperature within the reactor at 25° C., adding methylbenzene 71.1 g, then octadecylamine 60 g into the monomer reactor, stirring till dissolved; then adding acrylic acid 18 g and 4-methylbenzenesulfonic acid 0.3 g, stirring till dissolved. Sealing the reactor and raising the temperature to 90° C. for 24 hours, while removing water from it using the water separator. Next, conducting the reduced pressure distillation at 85° C. for 12 hours or until no distillate distilled. The light-yellow oily solid products remained in the reactor are N-Methylolacrylamide.

2. Maintaining a temperature of 25° C. in yet another monomer reactor, adding ethanol 40 g, N,N-dimethyldocosylamine 75 g, stirring till dissolved; then, adding chloroacrlate 30 g, stirring till dissolved. Next, sealing said reactor, raising the temperature to 60° C. for 20 h for reacting, then conducting the reduced pressure distillation at 90° C. for 8 h or until no distillate distilled. The white solid products remained in said reactor are octadecyldimethylallyl ammonium chloride.

3. maintaining a temperature of 25° C. in a stirring reactor, adding de-ionized water 110 g, then methacrylic acid 20 g, potassium acrylate 20 g, 2-Acrylamide-2-methylpropanesulfonic acid (AMPS) 30 g, stirring till dissolved, then adding the multi-block associative monomers of N-Methylolacrylamide 6 g, octadecyldimethylallyl ammonium chloride 6 g, Dodecyl vinyl ether 8 g, stirring till dissolved. next adding ammonium persulfate 0.2 g, then sodium sulfite 0.2 g, azo-bis-iso-heptonitrile 0.5 g and 2,2′-azobis[2-(2-imidazolin-2-yl)propane) dihydrochloride 0.5 g to trigger the multi-step initiation. Raising the temperature to 80° C. for 6 hours for reacting.

4. Cooling down a product prepared from step 3 described hereabove, preparing the APCF2 from granulating, drying and grinding said product.

The APCF2 prepared from Embodiment 2 is in powder form, having the evaluating indicators described hereabove as 42 mPa·s at 20° C., 4 mPa·s after the gel breaking, and 150 min of the suspending sand time, respectively.

It is to be understood that the use of “including”, “comprising” or “consisting of” and variations thereof herein is meant to encompass the items listed thereafter and equivalents thereof as well as additional items; the terms “a” and “an” herein do not denote a limitation of quantity, but rather denote the presence of at least one of the referenced item; and, the use of terms “first”, “second”, and the like, herein do not denote any order, quantity, or importance, but rather are used to distinguish one element from another.

It is to be understood that the above embodiments and examples are provided as illustrations only, and do not in any way restrict or define the scope of the present invention. Various other embodiments may also be within the scope of the claims.

We claim:

1. A method of preparing a Clean Fracturing Fluid Thickener of Multi-block Associative Copolymer (APCF) having evaluating indicators described as: a viscosity of its 0.3% water solution at 20° C.≧30 mPa·s, a viscosity of said solution after gel breaking≦5 mPa·s, and, a static sand-suspending time≧10 min; comprising:
(i), preparing multi-block associative monomers, wherein said monomers all have a length of carbon chains between 8 and 22 and are selected from following: maleic acid n-alkyl ester sodium salt, n-alkyl acrylaminde, n-alkyl dimethylallyl ammonium chloride or n-alkyl dimethyl p-methyl-phenylethenyl ammonium chloride, and/or dimethyl-n-alkylamine;
wherein preparing the maleic acid n-alkyl ester sodium salt further comprising: (a) maintaining a temperature within a reactor at 10-30° C., (b) adding by total weight: 49.5-56.9% of methylbenzene, and 12-14% of maleic anhydride, stirring till dissolved, (c) adding by total weight: 26-30% of alcohol having the length of the carbon chains between 8 to 22, and 0.1-0.5% 4-methylbenzensulfonic acid, stirring till dissolved, (d) sealing the reactor air-tight, (e) raising the temperature within the reactor to 60-80° C. to initiate a reaction, (f) neutralizing the reaction by alkali 5-6% by total weight, (g) cooling down the reaction to a room temperature, and, (h) filtering the reaction to collect the maleic acid n-alkyl ester sodium salt;
wherein preparing the n-alkyl acrylaminde further comprising: (a) maintaining a temperature of a reactor at 10-30° C., (b) adding by total weight: 45.1-51.9% of methylbenzene, and 38-42% of long chain alkyl amine having the length of the carbon chains between 8-22, stirring till dissolved, (c) adding by total weight 10-12% of acrylic acid, 0.1-0.5% of 4-methylbenzenesulfonic acid, stirring till dissolved, (d) sealing the reactor air-tight, (e) raising the temperature of the sealed reactor to 85-95° C. for reacting, (f) removing water from the reactor, (g) distilling by a reduced pressure distillation at 80-90° C. until no distillates distilled, (h) collection the n-alkyl acrylaminde from the reactor;
wherein preparing the n-alkyl dimethylallyl ammonium chloride or the n-alkyl dimethyl p-methyl-phenylethenyl ammonium chloride comprising: (a) maintaining a temperature of a reactor at 10-30° C., (b) adding following components by total weight: 30-32% of ethanol, and 48-50% dimethyl-n-alkylamine having the length of the carbon chains between 8-22, stirring till dissolved, (c) adding following components by total weight: 18-22% chloroacrylate or 1-(chloromethyl)-4-ethenyl-benzen, stirring till dissolved, (d) sealing the reactor air-tight, (e) raising the temperature of the reactor to 50-60° C., (f) distilling the reduced pressure distillation at 80-90° C. until no distillate distilled, and, (g) collecting the n-alkyl dimethylallyl ammonium chloride or the n-alkyl dimethyl p-methyl-phenylethenyl ammonium chloride from the reactor;
(ii), synthesizing the Clean Fracturing Fluid Thickener of Multi-block Associative Copolymer (APCF), wherein synthesizing the Clean Frac Fluid Thickener of Multi-block Associative Copolymer (APCF) further comprising: (a) maintaining a temperature of a stirring reactor at 10-30° C., (b) adding by order and by total weight: 75% of de-ionized water, 20-35% of at least two water-soluble monomers containing vinyl groups, and 5-10% of two or more of the associative monomers, stirring till dissolved, (c) adding by total weight: 0.1-0.5% of redox initiators and 0.1-0.5% of azo-initiators, wherein the redox initiators consist of oxidizers and reducers, (d) raising the temperature of the stirring reactor at 80-95° C. for a multi-step initiation, and, (e) collecting polymers produced, which has a molecular weight between 200-400 million.

2. The method of claim 1, wherein the alkali is NaOH.

3. The method of claim 1, wherein the oxidizers may be any of the following: sodium persulfate, potassium persulfate, or ammonium persulfate; the reducers may be any of the following: sodium bisulphite or sodium sulfite; a ratio between the oxidizers and reducers may be 1:1 by weight.

4. The method of claim 1, wherein the azo-initiators may be any of the following: azo-bis-iso-butyrynitrile, azo-bis-iso-heptonitrile, 2,2′-azobis[2-(2-imiddazolin-2-yl)propane] dihydrochloride, and 2,2′-azobis(2-methylpropionamidine) dihydrochloride.

5. The method of claim 1, wherein the water-soluble monomers containing vinyl groups may be any two or more of the following: acrylamide, acrylic acid or methacrylic acid, sodium acrylate or potassium acrylate, sodium allylsulfonate, and 2-acrylamide-2-methylpropanesulfonic acid.

6. The method of claim 1, further comprising: post-treating by granulating, drying, grinding and packing of the Clean Fracturing Fluid Thickener of Multi-block Associative Copolymer (APCF).

7. A Clean Fracturing Fluid Thickener of Multi-block Associative Copolymer (APCF) having evaluating indicators described as: a viscosity of its 0.3% water solution at 20° C.≧30 mPa·s, a viscosity of said solution after gel breaking≦5 mPa·s, and, a static sand-suspending time of said solution≧10 min; prepared by a process comprising the steps of:
(i), preparing multi-block associative monomers; said monomers all have a length of carbon chains between 8 and 22 and are selected from following: maleic acid n-alkyl ester sodium salt, n-alkyl acrylamide, n-alkyl dimethylallyl ammonium chloride or n-alkyl dimethyl p-methyl-phenylethenyl ammonium chloride, and/or dimethyl-n-alkylamine.
wherein preparing the maleic acid n-alkyl ester sodium salt further comprises steps: (a) maintaining a temperature within a reactor at 10-30° C., (b) adding by total weight: 49.5-56.9% of methylbenzene, and 12-14% of maleic anhydride, stirring till dissolved, (c) adding by total weight: 26-30% of alcohol having the length of the carbon chains between 8 to 22, and 0.1-0.5% 4-methylbenzensulfonic acid, stirring till dissolved, (d) sealing the reactor air-tight, (e) raising the temperature within the reactor to 60-80° C. to initiate a reaction, (f) neutralizing the reaction by alkali 5-6% by total weight, (g) cooling down the reaction to a room temperature, and, (h) filtering the reaction to collect the maleic acid n-alkyl ester sodium salt,
wherein preparing the n-alkyl acrylaminde further comprises steps: (a) maintaining a temperature of a reactor at 10-30° C., (b) adding by total weight: 45.1-51.9% of methylbenzene, and 38-42% of long chain alkyl amine having the length of the carbon chains between 8-22, stirring till dissolved, (c) adding by total weight 10-12% of acrylic acid, 0.1-0.5% of 4-methylbenzenesulfonic acid, stirring till dissolved, (d) sealing the reactor air-tight, (e) raising the temperature of the sealed reactor to 85-95° C. for reacting, (f) removing water from the reactor, (g) distilling by a reduced pressure distillation at 80-90° C. until no distillates distilled, (h) collection the n-alkyl acrylaminde from the reactor,
wherein preparing the n-alkyl dimethylallyl ammonium chloride or the n-alkyl dimethyl p-methyl-phenylethenyl ammonium chloride comprises steps: (a) maintaining a temperature of a reactor at 10-30° C., (b) adding following components by total weight: 30-32% of ethanol, and 48-50% dimethyl-n-alkylamine having the length of the carbon chains between 8-22, stirring till dissolved, (c) adding following components by total weight: 18-22% chloroacrylate or 1-(chloromethyl)-4-ethenyl-benzen, stirring till dissolved, (d) sealing the reactor air-tight, (e) raising the temperature of the reactor to 50-60° C., (f) distilling by the reduced pressure distillation at 80-90° C. until no distillate distilled, and, (g) collecting the n-alkyl dimethylallyl ammonium chloride or the n-alkyl dimethyl p-methyl-phenylethenyl ammonium chloride from the reactor; and,
(ii), synthesizing the Clean Fracturing Fluid Thickener of Multi-block Associative Copolymer (APCF), wherein synthesizing the Clean Frac Fluid Thickener of Multi-block Associative Copolymer (APCF) further comprises steps: (a) maintaining a temperature of a stirring reactor at 10-30° C., (b) adding by order and by total weight: 75% of de-ionized water, 20-35% of at least two water-soluble monomers containing vinyl groups, and 5-10% of two or more of the associative monomers, stirring till dissolved, (c) adding by total weight: 0.1-0.5% of redox initiators and 0.1-0.5% of azo-initiators, wherein the redox initiators consist of oxidizers and reducers, (d) raising the temperature of the stirring reactor at 80-95° C. for a multi-step initiation, and, (e) collecting polymers produced, which has a molecular weight between 200-400 million.

8. The steps of claim 7, wherein the alkali is NaOH.

9. The steps of claim 7, wherein the oxidizers may be any of the following: sodium persulfate, potassium persulfate, or ammonium persulfate; the reducers may be any of the following: sodium bisulphite or sodium sulfite; a ratio between the oxidizers and reducers may be 1:1 by weight.

10. The steps of claim 7, wherein the azo-initiators may be any of the following: azo-bis-iso-butyrynitrile, azo-bis-iso-heptonitrile, 2,2′-azobis[2-(2-imiddazolin-2-yl)propane] dihydrochloride, and 2,2′-azobis(2-methylpropionamidine) dihydrochloride.

11. The steps of claim 7, wherein the water-soluble monomers containing vinyl groups may be any two or more of the following: acrylamide, acrylic acid or methacrylic acid, sodium acrylate or potassium acrylate, sodium allylsulfonate, and 2-acrylamide-2-methylpropanesulfonic acid.

12. The steps of claim 7, further comprising steps: post-treating by granulating, drying, grinding and packing of the Clean Fracturing Fluid Thickener of Multi-block Associative Copolymer (APCF).
